(19) United States
(12) Patent Application Publication
(10) Pub. No.: US 2008/0175607 A1
(43) Pub. Date: Jul. 24, 2008

(54) SYSTEM PROMPT OF DUAL TOP TRAY/PURGE TRAY PRIOR TO OUTPUT/PURGED SHEETS BEING SENT TO THE TOP TRAY

(75) Inventor: Keith L. WILLIS, Rochester, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/624,502

(22) Filed: Jan. 18, 2007

(51) Int. Cl. G03G 15/00

(52) U.S. Cl. 399/20

(57) ABSTRACT

A method and system for allowing user control of tray usage policy. In the event that a system purge signal is generated, indicating a purge of existing product in the production pathway, and a system sensor indicates that a tray is not empty, production output will be delayed until a user responds to an alert that existing product in the output tray may be mixed will the purged product, or until a predetermined time period has elapsed at which time the system will automatically perform the purge event, thereby mixing non-production quality product and production quality product in the tray. The user may be presented with options based on the operating mode of the image forming device.

### BACKGROUND

This disclosure is directed to systems and methods for defining an output tray usage policy in an image forming device.

Printers, copiers and other types of image forming devices have become necessary productivity tools for producing and/or reproducing documents. Such image forming devices include, but are not limited to, desktop copiers, stand-alone copiers, scanners, facsimile machines, photographic copiers and developers, and multi-function devices and other like systems capable of producing and/or reproducing image data from an original document, data file or the like.

As the technology expands, image forming devices are increasingly capable of detecting and correcting internal faults. The need for self-correcting technology is desirable to optimize overall cost performance and to minimize operational disruption. Similarly, as users become more dependent on producing and reproducing output documents, the need increases for quality collated products that are not contaminated with the inclusion of non-production quality pages.

Capabilities exist for various types of image forming devices to clear non-production quality output product from operating pathways at various times in image forming operations. Such capabilities depend on the systems themselves, the modes of operation of the systems, and/or the complexity of the image forming devices. In the event of a system fault, an image forming device may include a capability, or sub-system, initiated automatically by the image forming device or user initiated, to “purge” the image forming device, i.e., to clear non-production quality output product associated with the detected system fault from the image forming device. The purge may, or may not, cause a temporary production interruption within the image forming device. A purge event is one in which an image forming device, or a user, determines a need to clear, for example, the production pathways of any existing output product in the image forming device.

While this description will generally refer to the internal pathways of an image forming device, it should be recognized that such fault detection and clearing may also include external pathways, work areas and/or associated devices from which the output product may be transported before, during or after image forming operations in the image forming device. This would include units designed to transport the output product between a plurality of image forming devices, and/or additional devices used in the production of output product, such as, for example, a production quality completed and collated document. Such additional devices may include trimmers, binders and other like devices.

Once a purge event is determined to be required, a controller generally causes the image forming device to purge non-production quality output product from the production pathways of the image forming device, and any associated equipment as described above. The non-production quality output product is typically directed to an output tray. The output tray may also be the output location intended for depositing the various production quality output products. Production quality is defined as that particular degree of quality, of the production output product, that is anticipated for the image forming operating being performed in the image forming device. The purge event may potentially introduce non-production quality output product into an output tray with pre-existing production quality output product, or may potentially introduce production quality output product into an output tray with pre-existing non-production quality output product, thereby, contaminating the production quality output product with non-production quality output product.

### SUMMARY

A drawback with conventional methods and systems associated with image forming devices, is the potential to mix, under circumstances such as those described above, both production quality and non-production quality output product in a single tray. Production quality output product can be any product compatible with the image forming device that is of sufficient quality to be considered a final end product, with respect to the image forming device, and based on the capabilities of the image forming device. Non-production quality output product is that product that is compatible with the image forming device that is not of sufficient quality to be considered a final end product, with respect to the image forming device, and based on the capabilities of the image forming device, particularly output product that may be formed during a system malfunction, or even cause a system malfunction, such as, for example, a jam of the production pathways in an image forming device.

While the production quality and non-production quality output product, as described above refers to an image forming device, it is also anticipated that the image forming device will be used in conjunction with other image forming devices and/or production machines, i.e., scanners, binders, collators, cutters and like devices. While the image forming device performs a purge to expunge the product from the pathways of the image forming device, a user is currently not provided an opportunity to select, nor is any methodology in place for automatic selection of, a destination for the non-production quality output product generated by the purge event. This is true even if the system detects pre-existing production product in a designated tray and/or area of the image forming device.

The problem, as described above, is particularly acute when a user is remotely located from the image forming device, such as when operating by network based communications. The user may be totally unaware that the image forming device, which the user is attempting to employ to perform image production and/or reproduction, has performed a purge, and potentially introduced non-production quality output product into a tray that contains production quality output product, or introduces production quality output product into a tray that contains non-production quality output product.

In related art systems, the user may be notified that a purge is being executed, but there is no capability by which to re-direct, or reassign a destination for, the non-production quality output product as may be generated by a purge event. This situation often necessitates a user expending considerable time and effort in page checking a production copy to ensure that it is not contaminated by non-production output product pages. Related art systems likewise provide no means for identifying where non-production output product pages may be located within the production quality output product, thereby, requiring a user to individually page check an entire finished document. In the event that multiple purges occur during an image forming operation, the above-described problem is magnified considerably.

It would be advantageous, in view of the above-identified shortfalls, to provide methods and systems, within or related to one or more image forming devices, that would allow the system, or a user, to determine a next step in a image forming operation once it is determined by an image forming device, or an associated device, that a purge is required, particularly when such a purge determination is made at a point in an image forming operation where pre-existing production quality output product already exists in a designated output tray, or may potentially be introduced to the designated output tray after the purge event. For example, it would be beneficial to notify the user of a pending purge, and allow the user to remove any pre-existing production quality output product documents in a designated output tray, prior to initiating the system purge.

Additionally, it would be beneficial for a user to know that non-production quality output product is located in a designated output tray and may potentially contaminate the production quality output product being generated in the image forming operation. An additional advantage would be to allow the user to determine that the system purge should continue, despite the presence of pre-exiting output product of any quality in a designated output tray, thereby notifying the user that production quality output product may be contaminated with non-production quality output product and may require a page check to confirm a production quality output product is free of contamination. Furthermore, it would be beneficial to allow the user to cancel a pending image forming operation once a system purge is identified as being required, and the presence of pre-existing product quality output product in a designated output tray is detected. Alternatively, it would be advantageous, in such circumstances, to suspend the image forming operation until the system purge is completed and non-production quality output product generated by, or associated with, the system purge is removed from the designated output tray. Finally, it would be beneficial to provide a capability whereby a method or sub-system exists within an image forming device to redirect, automatically or via user input, non-production quality output product associated with a purge event, or otherwise generated in the image forming device, to a separately designated output tray in order that production quality output product is not contaminated.

It should be appreciated that a designated output tray receiving production quality product and the non-production quality product may be any tray within the pathway of an image forming device associated with an image forming operation. For example, in duplex operations where multiple sides of the associated output product are manipulated, an intermediate output tray may be used to temporarily store the production quality product. Additionally, where the image forming device allows for a plurality of steps in the production of the production quality product, it should be appreciated that any output tray within the production pathway of the image forming device or devices is anticipated as being considered selectable with respect to the disclosed methods and systems.

The systems and methods according to this disclosure may provide one or more designated tray sensors, or one or more multi-purpose tray sensors, for detecting the presence of product in a designated output or intermediate output tray of an image forming device in order that a user may be alerted to a potential for contamination of a production quality output product based on presence of other output product in the designated tray.

The systems and methods according to this disclosure may provide a system controller that detects the need for a system purge, initiates a system purge, and/or reports the occurrence of a system purge, based on multiple factors, including, but not limited to, product jam, software reset, user initiation, initial start-up and/or final shutdown. The system purge is reported in order that a determination may be made to effect segregation of non-production quality output product associated with the purge event from production quality output product in one or more designated output trays.

The systems and methods according to this disclosure may provide a user interface that allows a user the ability to interact with the image forming device in order that a user can, among other inputs, provide input to the image forming device to aid in effecting segregation of non-production quality output product, particularly such product as may be associated with a system purge, from production quality output product in one or more designated output trays. The user interface may be in communication with the image forming device by, for example, at least one of a web-based transfer network, either wired or wireless, and/or a local area transfer network, either wired or wireless, or may be otherwise installed within, for example, the image forming device, or one or more peripheral devices associated with the image forming device.

The systems and methods according to this disclosure may provide a timing device that allows a system controller to temporarily stop, and/or restart, an image forming in an image forming device, or operation of the image forming device overall, for at least a pre-determined time period in order that the systems and methods described herein may be variably timed to facilitate and effect segregation of non-production quality output product from production quality output product in one or more designated output trays in the image forming device.

The systems and methods according to this disclosure may provide a determination unit in communication with one or more sensors in an image forming device and with a system controller to make a determination regarding next steps in an image forming operation in the image forming device based on, for example, an indication of a requirement for a system purge, signals from one or more output tray sensors, presence of user input, and/or elapse of a pre-determined time period.

The systems and methods according to this disclosure may provide a communication unit that allows for remote operation of an image forming device by at least one of a web-based transfer network, either wired or wireless, and/or a local area transfer network, either wired or wireless, such that the systems and methods described herein may provide, or be provided, remote communications to effect segregation of non-production quality output product from a production quality output product.

These and other features and advantages of the disclosed embodiments are described in, or apparent from, the following detailed description of various exemplary embodiments.

### BRIEF DESCRIPTION OF THE DRAWINGS

Various exemplary embodiments of disclosed systems and methods will be described, in detail, with reference to the following figures, wherein:

FIG. 1 illustrates a flow diagram of a method for defining a tray usage policy in an image forming device;

FIG. 2 illustrates a block diagram of an exemplary embodiment of a system for defining a tray usage policy in an image forming device;

FIG. 3 illustrates an exemplary user menu for a system Purge Option according to the disclosure for use in defining a tray usage policy in an image forming device; and

FIG. 4 illustrates an exemplary user menu for an Output Destination Option according to the disclosure for use in defining a tray usage policy in an image forming device.

### DETAILED DESCRIPTION OF EMBODIMENTS

The following description of various exemplary embodiments of systems and methods for determining a tray usage policy in an image forming device may refer to and/or illustrate components of a xerographic image forming device as one specific type of system for the sake of clarity and ease of depiction and description. However, it should be appreciated that, in various exemplary embodiments, a tray usage policy in an image forming device, as illustrated, for example, in the figures, with principles disclosed herein, as outlined and/or discussed below, can be equally applied to any known, or later-developed, system in which trays are used to collectively accept production copy and purge copy in an image forming device. A tray usage policy, in an image forming device according to the systems and methods of this disclosure may find applicability in any system in which a tray is used to collect both production quality product and non-production quality product.

The systems and methods according to this disclosure provide a capability to prevent mixing of production quality output product and non-production quality output product in a tray designated to collect output image bearing product in an image forming device particularly where output product is generated during such time that a system purge is initiated. A system purge may be necessitated by the detected presence of pre-existing product within the production pathway of the image forming device. This condition may be the result of, but is not limited to, a paper or product jam, an internal calibration reset, a user-initiated action, or like occurrence. The capability incumbent in the disclosed systems and methods has as one of several objectives increasing output quality and reducing output errors by reducing mixture of production quality output product and non-production quality output product in one or more designated output trays in an image forming device.

One or more sensors may be placed in such a manner to detect the presence of any product in one or more designated output trays. It should be appreciated that the detection of product in a designated output tray may be accomplished by either a pre-existing, or specifically installed, multi-purpose or dedicated, sensor. Additionally, it should be appreciated that these detectors may be either wired or wireless, or any combination thereof, in their connection to the rest of the systems associated with the image forming device. If wireless, they may include radio frequency (RF) signal, ultra-sonic, optical or infra-red detection communication connections, and may incorporate any manner of sensor technology.

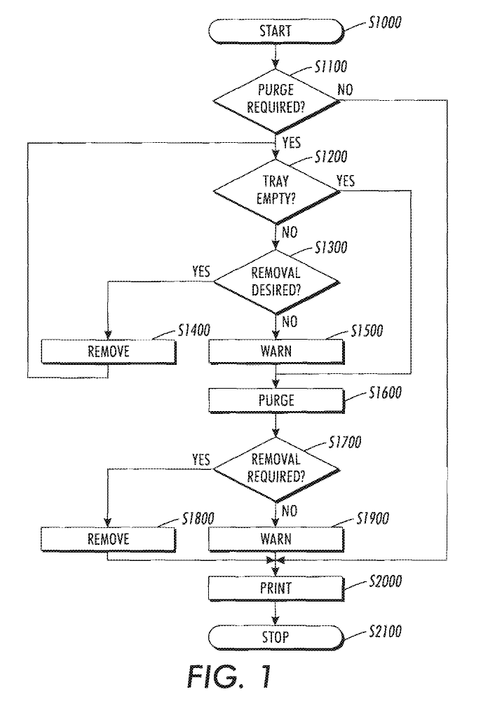

FIG. 1 is a flow diagram of an exemplary method for defining a tray usage policy in an image forming device. As shown in FIG. 1, operation of the method begins at step S1000 in which a method for determining tray usage policy is initiated. The method may be initiated automatically or manually, for example, by a user initializing the image forming device. Operation of the method continues to step S1100.

In step S1100, a determination is made if a system purge is required. If in step S1100, a determination is made that a system purge is not required, operation of the method proceeds directly to step S2000.

If in step S1100, a determination is made that a system purge is required, operation of the method continues directly to step S1200.

In step S1200, a determination is made if any product exists in a designated output tray. If, in step S1200, a determination is made that the designated output tray is empty, operation of the method proceeds directly to step S1600.

If in step S1200, a determination is made that the designated output tray is not empty, operation of the method continues to step S1300.

It should be appreciated that step S1200 may require some sensed input as to whether the designated output tray is empty or not. As indicated above, such sensed input may be available from any manner of sensors capable of reading the presence of the designated output tray.

In step S1300, a determination is made whether removal of any sensed output product from a non-empty designated output tray is required, or otherwise may be beneficial, based on, for example, a predetermined operating hierarchy for the image forming device, or by prompting a user input. Any manner by which a set of determination rules may be established is contemplated. If in step S1300, a determination is made that removal of any pre-existing output product in a designated output tray is not required, operation of the method continues to optional step S1500 or directly to step S1600.

If in step S1300, a determination is made that removal of pre-existing output product in the designated output tray is required, operation of the method continues to step S1400.

In step S1400, any pre-existing output product in the designated output tray is removed. This removal may be undertaken by some manner of automatically dumping the designated output tray, or may require manual user input. Such manual user input may be directed by presentation of, for example, direction to remove output product from the designated output tray, or by simply providing a user an indication of a choice to do so, provided to the user via some form of, for example, graphical user interface. Operation of the method reverts to step S1200.

It should be appreciated that a requirement or benefit of removing pre-existing output product from a destination output tray may be based on a number of factors effecting the determination made in step S1300. Such factors may include, but not be limited to, an operating mode of the image forming device. Such an operating mode determination may be, for example, whether in an automated purge mode or some manner of alternate operating mode in which purge is automatically accepted regardless of a condition of a designated output tray.

It should be further appreciated that other options may be provided to a user via, for example, a graphical user interface, if a system determines, for a given operating mode of the image forming device, that a specific combination of determinations in steps S1100, S1200 and S1300 should automatically inhibit and/or cancel, or request information regarding a manual inhibit and/or cancellation of, a particular image forming operation in the image forming device. Any range of such options is contemplated such that, for example, when a specific set of circumstances dictates that an image forming operation should be aborted, such abort may supersede, or be guided by determinations made in steps S1100, S1200, and S1300.

Optional step S1500 provides a warning to a user that purge is required when, for example, a determination is made that pre-existing output product in a designated output tray will not be removed. In such an instance, it may be advantageous to at least warn a user of the presence of non-production quality product within a set of output images representing production quality product for a specific image forming operation in the image forming device in order to reduce any need for a user to individually page check sets of output documents from the image forming device when certain conditions exist such that the production quality output product may be contaminated by non-production quality output product, for example, associated with an initiated purge event. Operation of the method continues to step S1600.

In step S1600, a previously-determined required or beneficial purge is executed subject to other conditions existing within the image forming device and determinations made in steps S1100-S1300. Operation of the method continues to step S1700.

In step S1700, a second determination is made post-purge whether non-production output product generated as a result of the purge in a designated output tray should be removed. If in step S1700, a determination is made that post-purge non-production quality output product should not be removed, operation of the method continues to optional step S1900, or directly to step S2000.

If in step S1700, a determination is made that the post-purge non-production quality product should be removed, operation of the method continues to step S1800.

In step S1800, post-purge non-production quality output product present in the designated output tray is removed.

In like manner to step S1400 above, step S1800 may include automatic dumping of the designated output tray, or may require manual intervention of a user in order to physically remove the post-purge non-production quality output product from the designated output tray.

In operation step S1900, a warning may be provided to a user or via some manner of graphical user interface, or otherwise, that post-purge non-production material is present in the designated output tray. Such a warning is available to inform a user that a later page check of the production quality product deposited in the designated output tray may be required in order to remove post-purge non-production quality output product from the designated output tray or the production quality product now potentially contaminated with non-production quality product. Operation of the method continues to step S2000.

In step S2000, the selected image forming operation is allowed to proceed subject to all the conditions specified in the above steps. Operation of the method continues to step S2100 where operation of the method ceases.

As indicated above, determinations may be made based on a system being operated in a particular operating condition such as, for example, a Purge Mode, or an Output Determination Mode. Differing options for further processing of an image forming operation may be undertaken based on the predetermined mode within which the system is being operated. For example, if being operated in an exemplary Purge mode, the system may temporarily interrupt the image forming operation for some predetermined time period.

In such a case where a predetermined time period may be beneficial, some manner of elapsed timer or and/or clock may be available to specify the predetermined time period by which the image forming operation may be delayed while a further determination is made regarding, for example, whether removal of non-production quality product is required or beneficial in either of the “Removal Required?” determination steps S1300 or S1700 shown in the exemplary method in FIG. 1. In either instance, removal of any output product from a designated output tray may be undertaken and such removal sensed by a sensing device within the tray before the method is allowed to proceed, or a manual input from a user may be required by, for example, requiring further initiation of the method by re-executing an image forming operation in the image forming device. Alternatively, automatic processing may occur and/or user input may be required regarding cancellation of the image forming operation in the image forming device prior to the predetermined time period elapsing.

Such a clock or delay function may be implemented by any known method by which a delay interval may be introduced in an image forming device.

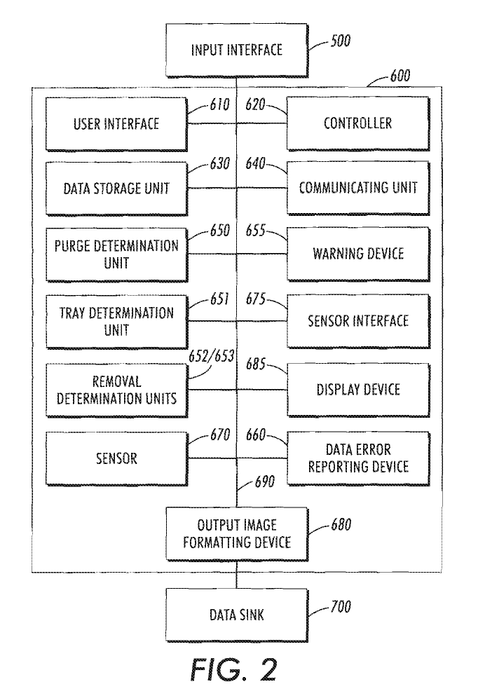

FIG. 2 illustrates a block diagram of an exemplary tray usage policy system 600 for determining output ray usage policy. As shown in FIG. 2, the exemplary system 600 may include an input interface 500, a user interface 610, controller 620, a data storage unit 630, a communication unit 640, a plurality of determination units 650-653, a warning device 655, a data error reporting device 660, one or more sensors 670, a sensor interface 675, an output data formatting device 680, a display device 685 and a data sink 700, all connected via a main data/control bus 690. Such main data/control bus 690 may include one or more wired or wireless connections to any of the involved devices, units or modules.

The tray usage policy system 600 may include a user interface 610 in order that a user can enter, or be able to view, any instruction, to include an ability to effect segregation of non-production quality output product from a production quality output product. The instructions may be viewable on a display device 685 associated with the image forming device. It should be appreciated that the user interface 610 is contemplated to allow for presentation and receipt of user messages in a full spectrum of audio and/or visual formats. The user interface 610 may be in communication with the various system components by the main data/control bus 690, or otherwise by any means by which data communication between the user interface 610 and the other components of the tray usage policy system 600 or the image forming device may be implemented.

The tray usage policy system 600 may include a controller 620 in order to monitor the various operations of the tray usage policy system 600 within the image forming device in order to effect and/or facilitate execution of the tray usage policy. The controller 620 may be in communication with the various system components by the main data/control bus 690, or otherwise by any means by which data communication between the controller 620 and the other components of the tray usage policy system 600 or the image forming device may be implemented.

The tray usage policy system 600 may include one or more determination units 650-653 used to compare various inputs from a variety of system components and to select appropriate methods of operation based on those determinations, as described above. The purge determination unit receives input from the controller 620 and determines if a purge is required. If the controller 620 indicates a need for a purge, then the system proceeds on to the tray determination unit 651. If the controller 620 does not indicate the need for a purge, then the system proceeds onto production of the designated output.

The tray determination unit receives input from the various sensors 670 regarding the presence of product in the designated output tray. If product is detected in the output tray, then the system initiates the first removal determination unit. If no product is detected in the designated output tray, then the purge is executed.

The first removal determination unit determines if the pre-existing product is to be removed from the designated output tray. If the pre-existing product is to be removed, then the tray usage policy system 600 waits for the removal of the pre-existing product. If the pre-existing product is not to be removed, then the user may be presented with a warning message that production quality product may be contaminated with non-production quality product.

The second removal determination unit determines if the purged non-production quality product is to be removed from the designated output tray. If the purged product is to be removed, then the tray usage policy system 600 waits for the removal of the purged product. If the purged product is not to be removed, then the user may be presented with a warning message that production quality product may be contaminated with non-production quality (purged) product.

The determination units 650-653 may be in communication with the various system components by the main data/control bus 690, or otherwise by any means by which data communication between the determination units 650-653 and the other components of the tray usage policy system 600 or the image forming device may be implemented.

The tray usage policy system 600 may include one or more sensors 670 presented to provide input to the tray usage policy system 600 regarding, for example, a status of one or more designated output trays, as described in the operation of the method above. The one or more sensors 670 may separately be located within one or more production pathways of the image forming device, various designated output trays, product input trays and at other locations that are contemplated, such as in work areas, sorters, duplexers and other like peripheral devices to the image forming device to sense the presence, or non-presence of production quality product, non-production quality product, purged product, or any combination thereof. The one or more sensors 670 may be in communication with the various system components by the main data/control bus 690, or otherwise by any means by which data communication between the one or more sensors 670 and the other components of the tray usage policy system 600 or the image forming device may be implemented.

The tray usage policy system 600 may include a communication unit 640 that is usable to communicate, receiving or transmitting, to local or remote users, additional image forming devices, or others systems. For example, the communications unit 640 may receive user input from a remotely-located user to the tray usage policy system 600; a user may be remotely located from the image forming device, and the user instructions, and graphical user interface menu prompts, warnings, and messages, may utilize the communications unit to communicate the status of the tray usage policy system 600 to the user. It is contemplated that a local and remote user shall have the same interaction with the tray usage policy system 600 of the image forming device, independent of location. Such communication may be effected, via the communication unit 640, with any of the various components of the tray usage policy system 600 or otherwise associated with the image forming device. It is also contemplated that the tray usage policy system 600 may be employed in a system of a plurality of image forming devices, that employs additional devices such as binders, sorters, distribution devices, scanners, etc.

It should be appreciated that communications may be undertaken with various components of the tray usage policy system 600, or otherwise in the image forming device with which the system 600 is associated, by either wired or wireless data exchange systems, as well as any combination thereof. Further, it should be appreciated that communications, as described above, are intended to include web-based network and local area network communications, in addition to remote, and/or local, operation from any manner of information or data exchange device such as, for example, personal computers and/or various other communication devices such as Personal Data Assistant's (PDA's), smart phones, and the like. The communication unit 640 and the communication interface 655 may be in communication with the various system components via the main data/control bus 690.

The tray usage policy system 600 may include a data storage unit 630 in order to allow for the retention of various operating parameters of the system 600. Such operating parameters may include, but are not limited to, the various sensor 670 inputs, the status of the pre-determined timing unit, user instructions received by any means, including the graphical user interface, and the status of the various determination units 650-653. It is contemplated that the operating parameters shall be stored within the data storage unit 630 until such time as the parameters are changed based on the systems and methods described relating to the tray usage policy system 600. The data storage unit 630 may be in communication with the various system components via the main data/control bus 690, or otherwise by any means by which data communication between the data storage unit 630 and the other components of the system 600 or the image forming device may be implemented.

In various exemplary embodiments, the image forming device may include an initiating device that allows a user to initiate the image forming device functions or an image forming operation in the image forming device. Input provided, for example, via the user interface 610, may initialize the functioning of the image forming device and activate, for example, the controller 620 of the exemplary tray usage policy system 600. The user interface 610 may be one of several available methods or devices for initiating the image forming device. Once the image forming device is initialized, the purge determination unit 650 of the tray usage policy system 600 may determine if a purge event indicated as being required or beneficial at this point in the operation of the image forming device by means of the input interface 600 and the controller 620. It is contemplated the user may initialize the image forming device by any means provided, including but not limited to a graphical user interface, a wired or wireless internet based network, and a wired or wireless local area network. Once the image forming device has been initialized, the tray usage policy system 600 is activated and proceeds to the purge determination unit 650.

Communication may occur between the controller 620 and the purge determination unit 650, upon initialization of the image forming device, to determine if a purge is either required or beneficial. The purge determination unit 650 detects the indication of a required or beneficial purge event and the initializing of the exemplary tray usage policy system 600. If the purge determination unit 650 determines that a purge event is required or would be beneficial, then the purge determination unit 650 may communicate such a determination to the controller 620 which in turn seeks input form a tray status determination unit 651. If the purge determination unit 650 does not determine that both a purge event is required or beneficial and that the exemplary tray usage policy system 600 has been initialized, then the purge determination unit 650, maybe in communication with the controller 620, may allow the purge event to proceed.

The first removal determination unit 652 may determine a requirement or a benefit to remove sensed output product from the designated output tray. If the first removal determination unit 652 determines that the sensed output product does not need to be removed from the output tray, then the first removal determination unit 652, in communication with the controller 620, may allow the purge event to proceed.

It should be appreciated that removal of any output product from a designated output tray may be undertaken by some manner of automatically dumping the designated output tray, or may otherwise require manual user input. Such manual user input may be directed by presentation of, for example, direction to remove output product from the designated output tray presented to a user via the user interface 610.

It should be appreciated that a requirement to remove pre-existing output product from the designated output tray may be based on a number of factors affecting the determination made by the first removal determination unit 652. Such factors may include, but not be limited to, an operating mode of the image forming device, for example, whether in an automated Purge Mode or an alternate operating mode in which purge is automatically accepted regardless of a condition of a designated output tray.

It should be appreciated that the various determination units 650-652 described above, may require some sensed input from various sensor 670 of the image forming device. These sensors 670 may provide one or more designated tray sensors, or one or more multi-purpose tray sensors, for detecting the presence of output product in a designated output tray of an image forming device in order that a user may be alerted to a potential for contamination of production quality output product in the designated output tray.

It should be further appreciated that other options may be provided to a user via the user interface 610 if a system determines, for a given operating mode of the image forming device, that a specific combination of the purge determination unit 650, the tray determination unit 641 and/or the first removal determination unit 652 inputs should automatically inhibit and/or cancel, or request information regarding a manual inhibit and/or cancellation of, a particular image forming operation within the image forming device. Any range of such options is contemplated such that, for example, when a specific set of circumstances dictates that an image forming operation should be aborted; such abort may superseded, or be guided by the purge determination unit 650, the tray determination unit 651 and/or the first removal determination unit 652.

A second removal determination unit 653 may be initiated post-purge to determine whether non-production output product generated as a result of a purge present in a designated output tray should be removed. If the second removal determination unit 653 determines that that the post-purge non-production quality product should be removed, then the output product may be removed by automatic or manual means, as discussed above. If the second removal determination unit 653 determines that the post-purge non-production quality product should not be removed, the selected image forming operation may be allowed to proceed, subject to all the conditions discussed above in operation of the exemplary tray usage policy system 600.

It should be appreciated that the second removal determination unit 653, may require some sensed input from various sensors 670 of the image forming device. These sensors 670 may provide one or more designated tray sensors, or one or more multi-purpose tray sensors, for detecting the presence of output product in a designated output tray of an image forming device in order that a user may be alerted to a potential for contamination of production quality output product in the designated output tray.

It should be appreciated that a requirement or benefit of removing post-purge product from output tray may be based on a number of factors affecting the outcome of the determination made by the second removal determination unit 653. Such factors may include Those discussed above with respect to various operating modes, for example, of the involved image forming device.

An exemplary embodiment of the tray usage policy system 600 may provide a warning device 655 that may be used to warn a user that purge is required, or may be beneficial when a second removal determination unit 653 indicates that pre-existing product in a destination tray will not be removed. In such an instance, it may be advantageous to at least warn a user of the presence of non-production quality output product within a production quality output product that results from a specific image forming operation in an image forming device in order to reduce any need for a user to individually page check sets of production quality output product from the image forming device that may be contaminated by non-production quality product.

The warning device 655 may be used alternatively to warn a user, or otherwise, via some manner of graphical user interface 610 that post-purge non-production output product is present in the designated output tray. Such a warning device 655 may generate a warning to inform a user that a later page check of the production quality output product deposited in the destination output tray may be required in order to remove post-purge non-production output product from the designated output tray.

It should be appreciated that, while shown in FIG. 2 as a single composite unit internal to the exemplary tray usage policy system 600, the system 600 may be either a unit and/or capability internal to the image forming device, internal to any component of the image forming device, or may be separately presented as a stand-alone system, unit, or device such as, for example, a separate server connected to the image forming device. Further, it should be appreciated that each of the individual elements depicted as part of the exemplary tray usage policy system 600 may be implemented as part of a single composite unit or as individual separate devices. For example, the determination unit 650, controller 620, and sensors 670 may be integral to a single composite unit communicating with other components of the overall system 600. Further, as noted above, it should be appreciated that, while depicted as separate units, the determination unit 650, controller 620, and sensors 670 may be separately attachable to the system as composite multi-function input/output components such as, for example, multi-function devices which include determination unit/controller/sensor capability all within a single unit with a user interface as part of the single composite unit.

It should be appreciated that given the required inputs, software algorithms, hardware circuits, and/or any combination of software and hardware control elements, may be used to implement the individual devices and/or units in the exemplary tray usage policy system 600.

It should be appreciated further that any of the data storage devices depicted in FIG. 2, or otherwise as described above, can be implemented using any appropriate combination of alterable, volatile or non-volatile memory, or non-alterable, or fixed, memory. The alterable memory, whether volatile or non-volatile can be implemented using any one or more of static or dynamic RAM, a floppy disk and associated disk drive, a writeable or re-writeable optical disk and associated disk drive, a hard drive/memory, and/or any other like memory and/or device. Similarly, the non-alterable of fixed memory can be implemented using any one or more of ROM, PROM, EPROM, EEPROM and optical ROM disk, such as a CD-ROM or DVD-ROM disk and compatible disk drive or any other like memory storage medium and/or device.

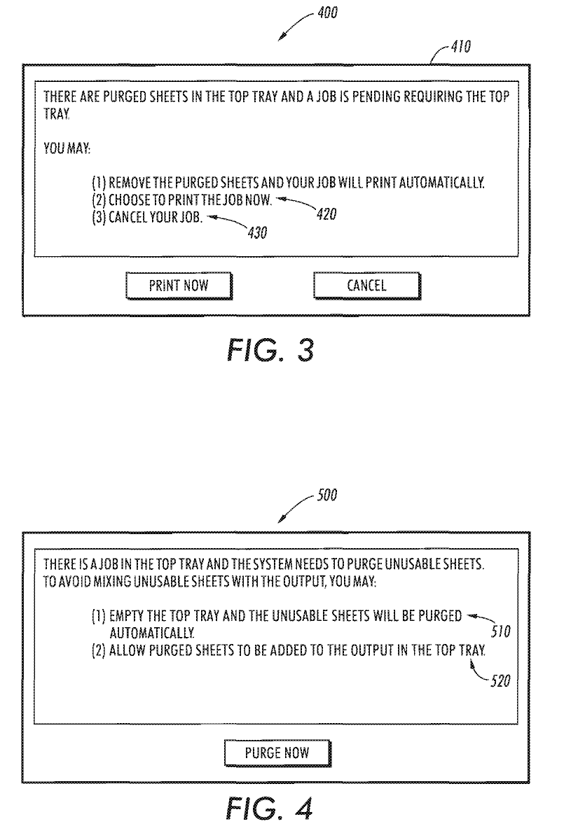

FIG. 3 graphically illustrates an exemplary embodiment of a Purge Mode Menu 400 for use in association with the systems and methods according to this disclosure. It should be appreciated that an image forming device may be operated in various operating modes depending on the desired production quality output product, and/or the various embodiments of the image forming device. Depending on the mode in which the image forming device is operated, various embodiments of user menus may be displayed on the display device 685.

For example, the image forming device may be operated in a Purge Mode (see display 400) in which the user is provided the option of (1) removing 410 detected product from a designated output tray, (2) printing 420 the production quality output product, and (3) canceling 430 the image forming operation.

Additionally, FIG. 4 graphically illustrates an exemplary embodiment of an Output Determination Mode Menu 500. The user is provided the option of (1) performing 520 the system purge, and (2) removing 510 the product from the tray.

The above detailed description of exemplary embodiments of systems and methods for defining an output tray usage policy in an image forming device is meant to be illustrative, and in no way limiting. The above detailed description of systems and methods is not intended to be exhaustive or to limit this disclosure to any precise embodiments or feature disclosed. Modifications and variations are possible in light of the above teaching. The above embodiments were chosen in order to clearly explain the principles of operation of the systems and methods according to the disclosure and their practical application to enable others skilled in the art to utilize various embodiments, potentially with various modifications, suited to a particular use contemplated. Also, various presently unforeseen or unanticipated alternatives, modifications, variations or improvements therein may be subsequently made by those skilled in the art, and are also intended to be encompassed by the following claims.

What is claimed is:

1. A method for implementing a tray usage policy comprising:
determining, during an image forming operation in an image forming device, that a purge event should be initiated in the image forming device;
detecting a presence of an output product in an output tray; and
processing the purge event based on the detected presence of the output product in the output tray.

2. The method of claim 1, wherein determining that the purge event should be initiated further comprises receiving an input signal regarding an operation condition of the image forming device and conditions within the image forming device defining a need for the purge event.

3. The method of claim 1, wherein detecting the presence of the output product in the output tray further comprises receiving an input signal from at least one sensor associated with the output tray regarding the presence of the output product in the output tray.

4. The method of claim 1, further comprising, when the presence of the output product is detected in the output tray, determining that the output product should be removed prior to processing the purge event.

5. The method of claim 4, further comprising removing the output product from the output tray when it is determined that the output product should be removed.

6. The method of claim 1, further comprising generating a warning message to be communicated to a user when the presence of the output product is detected in the output tray.

7. The method of claim 1, wherein processing the purge event further comprises executing the purge event when the presence of no output product is detected in the output tray.

8. The method of claim 1, wherein processing the purge event further comprises suspending the purge event for a predetermined time interval when the presence of the output product is detected in the output tray.

9. The method of claim 8, further comprising executing the purge event after the predetermined time interval has elapsed.

10. The method of claim 1, further comprising, when processing the purge event generates output purge product in the output tray, determining if the output purge product should be removed prior to continuing the image forming operation in the image forming device.

11. The method of claim 10, wherein, when it is determined that the output purge product should be removed, removing the output purge product prior to completing the image forming operation in the image forming device.

12. The method of claim 10, wherein, when it is determined that the output purge product should be removed, generating a warning message to a user regarding the presence of output purge product, and awaiting user input prior to completing the image forming operation in the image forming device.

13. The method of claim 10, wherein, when it is determined that the output purge product should be removed, waiting for another predetermined time interval to elapse prior to completing the image forming operation in the image forming device.

14. The method of claim 13, wherein a user may select the another predetermined time interval.

15. A system for establishing a tray usage policy, comprising:
a system controller that determines an operating condition of an image forming device;
a purge determination unit that receives an input that a purge event should be initiated in an image forming device based on the operating condition of the image forming device; and
a tray determination unit that determines a presence of an output product in an output tray;
wherein the controller processes the purge event based on determinations made in the purge determination unit and the tray determination unit.

16. The system of claim 15, further comprising at least one sensor to detect the presence of the output product in the output try with which the sensor is associate, the sensor communication the presence of the output product to the system via a system interface.

17. The system of claim 15, further comprising at least a first removal determination unit that determines that the output product should be removed from the output tray before proceeding with the purge event.

18. The system of claim 15, further comprising a warning device that generates a warning message prior to processing the purge event when the presence of output product is detected in the output tray.

19. The system of claim 15, further comprising at least a second determination unit that determines whether output purge product generated as a result of the processing of the purge event should be removed from the output tray prior to processing an image forming operation in the image forming device.

20. The system of claim 15, wherein the image forming device is a xerographic image producing device.
